(19) United States
(12) Patent Application Publication
(10) Pub. No.: US 2023/0050351 A1
(43) Pub. Date: Feb. 16, 2023

(54) SKIN CLEANING DEVICE

(71) Applicant: RUNNER(XIAMEN) CORP., Xiamen (CN)

(72) Inventors: Jieyang LIN, XIAMEN (CN); Zhenjiang ZHANG, XIAMEN (CN); Xiaomei YAN, XIAMEN (CN); Jinlin CHEN, XIAMEN (CN); Taoyan ZHANG, XIAMEN (CN); Quanlao WANG, XIAMEN (CN); Wen GAO, XIAMEN (CN)

(73) Assignee: RUNNER(XIAMEN) CORP., XIAMEN (CN)

(21) Appl. No.: 17/885,580

(22) Filed: Aug. 11, 2022

(30) Foreign Application Priority Data
Aug. 11, 2021 (CN) 202121875151.3

(51) Int. Cl. A61H 33/14; C02F 1/461; A61H 33/00

(52) U.S. Cl. CPC A61H 33/14; C02F 1/46109; C02F 1/4618; A61H 33/005; A61H 33/6068; C02F 2001/46152; C02F 2001/4619; C02F 2103/026

(57) ABSTRACT

A skin cleaning device includes a body, the body is provided with a water storage tank, the water storage tank includes a clean water tank and a waste water tank, the body is provided with an electrolytic device, the water inlet of the electrolytic device is connected with the clean water tank, the water outlet of the electrolytic device is connected with a suction nozzle capable of contacting with the skin, the suction nozzle is also connected with a pump body, and the water outlet end of the pump body is connected with the waste water tank. The device can immediately generate hydrogen rich water with high efficiency and avoid wasting waiting time for electrolysis.

### CROSS REFERENCE TO THE RELATED APPLICATIONS

This application is based upon and claims priority to Chinese Patent Application No. 202121875151.3, filed on Aug. 11, 2021, the entire contents of which are incorporated herein by reference.

### TECHNICAL FIELD

The utility model relates to a skin cleaning device.

### BACKGROUND

Hydrogen rich water refers to water rich in certain hydrogen. Hydrogen rich water is now a very effective antioxidant. It can activate cells and promote human metabolism. Harmful oxygen free radicals are not only the root of human diseases and aging, but also the direct cause of skin aging. Therefore, the skin absorbs hydrogen ions by perfunctory hydrogen rich water, which can timely remove the harmful oxygen free radicals generated on the skin surface, so as to achieve the effect of skin cleansing and beauty.

In the existing skin cleaning blackhead instrument, there are mainly the following ways: one is to use the suction of the vacuum pump for dry suction, the disadvantage is that the excessive suction will lead to skin damage; the other is a hydrogen rich skin beautifying instrument disclosed in Chinese patent application CN209808985U, including skin beautifying body, solution tank, hydrogen and oxygen generator, skin cleaning head, etc. because the technical scheme is to place the hydrogen and oxygen generator at the bottom of the solution tank, when in use, the hydrogen concentration in the solution tank will increase only after the hydrogen and oxygen generator electrolyzes for a certain time, which is time-consuming.

### SUMMARY

In order to solve the above technical problems, the utility model provides a skin cleaning device.

The utility model is realized by the following technical solutions:

A skin cleaning device, it includes a body, the body is provided with a water storage tank, the water storage tank includes a clean water tank and a waste water tank, the body is provided with an electrolytic device, the water inlet of the electrolytic device is connected with the clean water tank, the water outlet of the electrolytic device is connected with a suction nozzle capable of contacting with the skin, the suction nozzle is also connected with a pump body, and the water outlet end of the pump body is connected with the waste water tank.

In the embodiment of the utility model, the electrolytic device is an electrolytic hydrogen production device.

In the embodiment of the utility model, the electrolytic device includes a shell, an electrolytic chamber is arranged in the shell, the water inlet end of the electrolytic chamber is connected with the clean water tank, and the water outlet end of the electrolytic chamber is connected with the suction nozzle.

In the embodiment of the utility model, an anode sheet and a cathode sheet matched with each other are arranged in the electrolytic chamber.

In the embodiment of the utility model, the anode sheet and cathode sheet are fixed in the electrolytic chamber by locking bolts and nuts, the nuts are located outside the shell, and the power interface of the anode sheet and cathode sheet is located outside the shell.

In the embodiment of the utility model, the suction nozzle is provided with a groove, and the groove can form a sealing cavity with the skin.

The utility model relates to a skin cleaning device, which has the following advantages: it can immediately generate hydrogen rich water with high efficiency and avoid wasting waiting time for electrolysis; at the same time, it can make electrolytic water with micro bubbles during electrolysis for better cleansing effect.

### BRIEF DESCRIPTION OF THE DRAWINGS

In order to more clearly explain the technical scheme of the utility model, the following will briefly introduce the embodiments or the drawings required in the description of the prior art. It is obvious that the drawings in the following description are only some embodiments of the utility model. For ordinary technicians in the art, other drawings can be obtained according to these drawings without paying creative labor.

FIG. 1 is the first schematic diagram of the utility model.

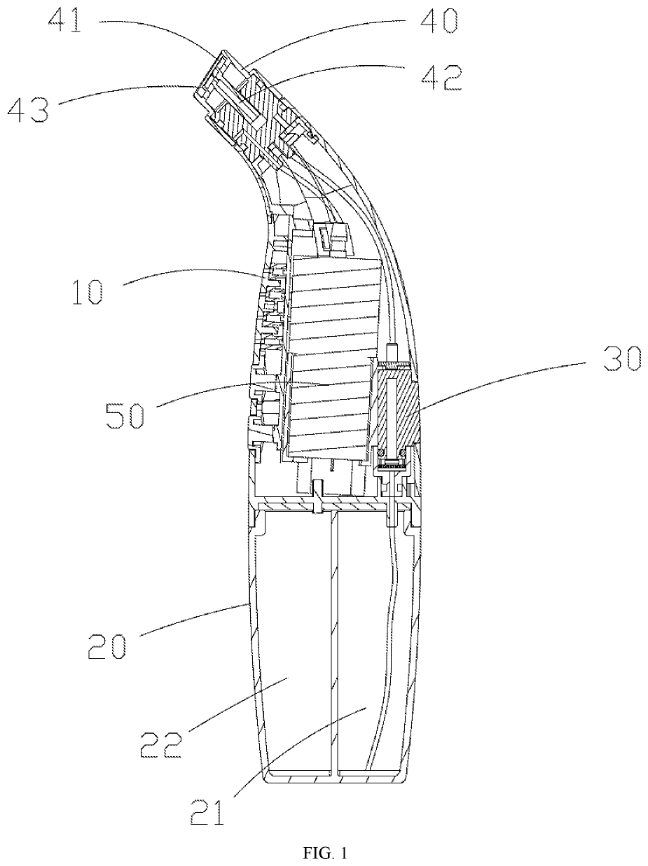

FIG. 2 is the second schematic diagram of the utility model.

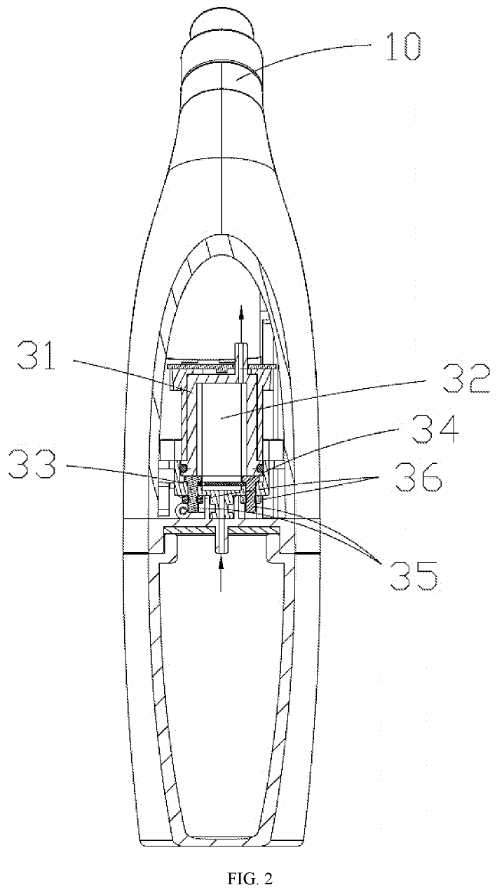

### DETAILED DESCRIPTION OF THE EMBODIMENTS

Next, the technical scheme in the embodiment of the utility model will be clearly and completely described in combination with the attached drawings in the embodiment of the utility model. Obviously, the described embodiments are only part of the embodiments of the utility model, not all of the embodiments. Based on the embodiments of the utility model, all other embodiments obtained by ordinary technicians in the art without creative work belong to the protection scope of the utility model.

“One embodiment” or “embodiment” herein refers to specific features, structures or characteristics that can be included in at least one implementation of the utility model. In the description of the utility model, it should be understood that the orientation or position relationship indicated by the terms “up”, “down”, “top”, “bottom” and so on is based on the orientation or position relationship shown in the attached drawings, which is only for the convenience of describing the utility model and simplifying the description, rather than indicating or implying that the device or element must have a specific orientation, be constructed and operated in a specific orientation, Therefore, it cannot be understood as a limitation of the utility model. In addition, the terms “first” and “second” are only used for descriptive purposes and cannot be understood as indicating or implying relative importance or implicitly indicating the number of indicated technical features. Thus, the features defined with “first” and “second” can explicitly or implicitly include one or more of the features. Moreover, the terms “first”, “second” and the like are used to distinguish similar objects, and do not have to be used to describe a specific order or order. It should be understood that the data used in this way can be interchanged under appropriate circumstances, so that the embodiments of the utility model described here can be implemented in an order other than those illustrated or described here.

Referring to the drawings of the specification, a skin cleaning device includes a body 10, the body is provided with a water storage tank 20, the water storage tank includes a clean water tank 21 and a waste water tank 22, the body is provided with an electrolytic device 30, the water inlet of the electrolytic device is connected with the clean water tank, the water outlet of the electrolytic device is connected with a suction nozzle 40 capable of contacting with the skin, and the suction nozzle is also connected with a pump body 50, and the water outlet end of the pump body is connected with the waste water tank.

In the embodiment, the electrolytic device is an electrolytic hydrogen production device.

Specifically, the electrolytic device includes a shell 31, an electrolytic chamber 32 is arranged in the shell, the water inlet end of the electrolytic chamber is connected with the clean water tank, and the water outlet end of the electrolytic chamber is connected with the suction nozzle. An anode sheet 33 and a cathode sheet 34 matched with each other are arranged in the electrolytic chamber. The anode sheet and cathode sheet are fixed in the electrolytic chamber by locking bolts 35 and nuts 36, the nuts are located outside the shell, and the power interface of the anode sheet and cathode sheet is located outside the shell.

In a preferred embodiment of the utility model, the suction nozzle is provided with a groove 41, and the groove can form a sealing cavity with the skin.

In one use, the utility model includes a body, a water storage tank, an electrolytic generator (i.e. the above-mentioned electrolytic device), a pump body, a suction nozzle, etc. The suction nozzle is provided with a liquid outlet channel 42 and an adsorption channel 43, and the suction nozzle can contact with the user's skin to form a sealing cavity. The electrolytic generator is built in the body, the water inlet of the electrolytic generator is connected with the clean water tank, and the water outlet is connected with the liquid outlet channel of the suction nozzle, the water inlet of the pump body is connected with the adsorption channel of the suction nozzle, and the water outlet is connected with the waste water tank. When the pump body works, it generates suction to drive the water flow of the clean water tank through the electrolytic generator. When the electrolytic generator electrolyzes, a large amount of hydrogen precipitates from the cathode and immediately dissolves in the water to form hydrogen rich water, which then flows to the suction nozzle and contacts the skin. After washing the skin, it takes away the dirt to the waste water tank. The utility model also includes a power supply, circuit board and other components arranged in the body.

The above description shows and describes the preferred embodiment of the utility model. As mentioned above, it should be understood that the utility model is not limited to the form disclosed herein and should not be regarded as the exclusion of other embodiments, but can be used in various other combinations, modifications and environments, and can be changed through the above teaching or technology or knowledge in relevant fields within the scope of the concept of the utility model described herein. The changes and changes made by those in the art do not deviate from the spirit and scope of the utility model, so they should be within the protection scope of the claims attached to the utility model.

What is claimed is:

1. A skin cleaning device, comprising a body, the body is provided with a water storage tank, the water storage tank comprises a clean water tank and a waste water tank, the body is provided with an electrolytic device, a water inlet of the electrolytic device is connected with the clean water tank, a water outlet of the electrolytic device is connected with a suction nozzle, wherein the suction nozzle is configured for contacting with a skin, the suction nozzle is further connected with a pump body, and a water outlet end of the pump body is connected with the waste water tank.

2. The skin cleaning device according to claim 1, wherein the electrolytic device is an electrolytic hydrogen production device.

3. The skin cleaning device according to claim 1, wherein the electrolytic device comprises a shell, an electrolytic chamber is arranged in the shell, a water inlet end of the electrolytic chamber is connected with the clean water tank, and a water outlet end of the electrolytic chamber is connected with the suction nozzle.

4. The skin cleaning device according to claim 3, wherein an anode sheet and a cathode sheet are arranged in the electrolytic chamber, the anode sheet and the cathode sheet are matched with each other.

5. The skin cleaning device according to claim 4, wherein the anode sheet and the cathode sheet are fixed in the electrolytic chamber by locking bolts and nuts, the nuts are located outside the shell, and a power interface of the anode sheet and a power interface of the cathode sheet are located outside the shell.

6. The skin cleaning device according to claim 1, wherein the suction nozzle is provided with a groove, and the groove is configured to form a sealing cavity with the skin.

7. The skin cleaning device according to claim 2, wherein the electrolytic device comprises a shell, an electrolytic chamber is arranged in the shell, a water inlet end of the electrolytic chamber is connected with the clean water tank, and a water outlet end of the electrolytic chamber is connected with the suction nozzle.

8. The skin cleaning device according to claim 2, wherein the suction nozzle is provided with a groove, and the groove is configured to form a sealing cavity with the skin.

9. The skin cleaning device according to claim 5, wherein the suction nozzle is provided with a groove, and the groove is configured to form a sealing cavity with the skin.
